(19) United States
(12) Patent Application Publication
(10) Pub. No.: US 2011/0225553 A1
(43) Pub. Date: Sep. 15, 2011

(54) Use Of Standalone Mobile Devices To Extend HID Capabilities Of Computer Systems

(76) Inventors: Robert W. Abramson, Pittsburgh, PA (US); Ronald Abramson, New York, NY (US)

(21) Appl. No.: 13/047,174

(22) Filed: Mar. 14, 2011

Related U.S. Application Data
(60) Provisional application No. 61/314,101, filed on Mar. 15, 2010.

(51) Int. Cl. G06F 3/033; G06F 3/14

(52) U.S. Cl. 715/863; 715/864

(57) ABSTRACT

A mobile device is adapted so that its HID functionality may be used to control an associated computer GUI. The computer may also be used to extend the HID capabilities of the mobile device.

### CROSS-REFERENCE TO RELATED APPLICATIONS

This application claims the benefit of the filing date of U.S. Provisional Patent Application Ser. No. 61/314,101, filed Mar. 15, 2010, the entire content of which is hereby incorporated by reference.

### BACKGROUND OF THE INVENTION

1. Field of the Invention

The present invention relates to human input devices for computers having graphical user displays, and more particularly to the adaptation of mobile phones and similar hand-held devices, and computers, whereby one and/or the other device provides extended HID functionality to the other.

2. Description of the Related Art

Computers with graphical user interfaces (GUIs) presuppose the availability of human input devices (HIDs). HIDs such as keyboards, mice, trackballs, tablets, etc. are well known.

Heretofore, HIDs have tended to be dedicated devices, that is, dedicated to the task of serving as a human input device for a specified computer, or for a group of computers among which the device may be shared, for example, with a keyboard-video-monitor (KVM) switch, or via software, such as Synergy, an open source mouse and keyboard sharing utility available at synergy2.sourceforge.net, the contents of which site is hereby incorporated by reference.

As dedicated devices attached to general purpose machines (the computers), HIDs have tended to feature what may be considered a “common denominator” of functionality. While enhanced mice, touchpads, keyboards and tablets are available for computers, the cost and specialization of these devices are often not seen as worthwhile, as they each represent an additional hardware purchase for an already existing system, and additional controls to become familiar with; unless the user regularly performs a particular task or activity requiring such devices, their additional cost and complexity may not be perceived as justified.

In a parallel development, mobile devices such as mobile phones and PDAs have advanced rapidly in providing a new range of HID controls to the user. These include, for example, multi-touch displays, which support multiple-finger pointing device gestures, providing the ability to finely control the mobile device, using expressive hand/finger movements. Users have rapidly adopted these devices, and have become comfortable with the multi-touch controls and gestures. However, the only devices that the gesture-based HID systems on mobile phones and PDAs have heretofore been used to control are the GUI displays of the mobile device itself.

Touchpads and similar dedicated devices are available for computers, particularly laptops, which incorporate multi-touch and similar functionality supporting, e.g., gesture input. However, these input devices, while often touch-sensitive, typically lack their own internal screen displays. They are also dedicated devices, either built into the computer (e.g., in the case of a laptop), or representing a separate purchase of a dedicated peripheral.

In addition, mobile devices have also introduced input elements not commonly found on computers, such as accelerometers and compasses. Some game controllers have some such additional functionality, but these also represent an additional hardware purchase for the computer user. Mobile devices also have specialized outputs that can be useful for human interaction, including vibration elements, sounds, ring tones, etc.

Furthermore, mobile devices incorporate ever-increasing screen capabilities, including relatively high resolutions and touch sensitivity, which in some respects rival or even surpass the capabilities of computer displays. Mobile devices may also provide high-quality cameras and sound systems, representing resources that may not be available to the computer, or of higher quality than what the computer may have natively. Similarly, the mobile device may have connectivity, such as for telephony and/or network access, that could be useful to a computer.

It is well known to connect a mobile device to a computer, for example, to download static content such as files and/or mount the mobile device's storage to serve as removable storage on the computer, and for “tethering”, to make the mobile device's wireless connectivity available as a network connection for the computer. However, these techniques have not been used to extend the HID capabilities of the computers to which the mobile devices are attached.

### SUMMARY OF THE INVENTION

Accordingly, it would be useful to be able to adapt a standalone mobile device so that its HID functionality may be used to extend an associated computer GUI. In another respect, it would also be useful if a computer could be used to overcome limitations inherent in the small size of such a mobile device.

To address these objectives, in one embodiment, software is provided to run on the standalone mobile device, to adapt the device to operate in a mode whereby signals responsive to human input to the mobile device through its touch-sensitive screen and/or other HID resources are transmitted to an associated computer, so that the mobile device may serve as an enhanced HID for the associated computer.

In another aspect, driver or other software may be provided, or adapted, on the associated computer, to handle HID inputs that are not native to the associated computer, and thereby extend the HID capabilities of the computer. In some embodiments, such software, tailored to the specific HID capabilities of the mobile device, may be encapsulated within the mobile device, and provided to the computer on demand.

In another aspect, the output capabilities of the device might be used by the computer as well, for example, the display of the mobile device may be used to supplement the display space on the computer, and adapted to provide further HID functionality in conjunction with the supplemental display.

In a further aspect, the computer may be used to enhance the HID capabilities of the mobile device, in those respects in which the computer may have capabilities or hardware not natively available to the mobile device.

Other aspects and advantages of the invention will be apparent from the accompanying drawings and the detailed description that follows.

### BRIEF DESCRIPTION OF THE DRAWINGS

For a more complete understanding of the present invention and the advantages thereof, reference is now made to the following description taken in conjunction with the accompanying drawings, wherein like reference numerals represent like parts, in which:

FIG. 1 is a schematic/block (not drawn to scale) diagram showing a mobile device, computer and connection in accordance with one embodiment of the disclosure.

FIG. 2 is a schematic/block diagram (not drawn to scale) showing coordination of displays between a mobile device and a computer in accordance with one embodiment of the disclosure.

FIG. 3 is a schematic/block diagram (not drawn to scale) showing driver updating in accordance with one embodiment of the disclosure.

FIG. 4 is a schematic/block diagram (not drawn to scale) showing computer 2 displaying an application executing on mobile device 1 while receiving HID commands from mobile device 1, in accordance with one embodiment of the disclosure.

### DESCRIPTION OF THE PREFERRED EMBODIMENTS

The following is a detailed description of certain embodiments of the invention chosen to provide illustrative examples of how it may preferably be implemented. The scope of the invention is not limited to the specific embodiments described in the following detailed description, nor is it limited by any specific implementation, embodiment or characterization depicted in the accompanying drawings or stated or described in the invention summary or the abstract. In addition, nothing contained in this written description should be understood to imply any necessary order of steps where processes are described, except as may be specified by express claim language.

Mobile Device Extending HID Capabilities of a Computer

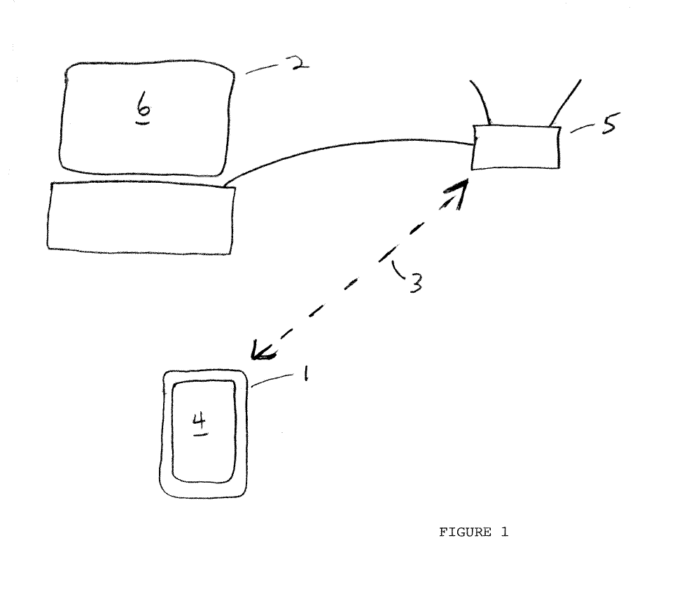

In one embodiment, as shown in FIG. 1, mobile phone 1 is adapted to serve as a human input device for computer 2.

In the particular embodiment shown, mobile device 1 is a mobile phone having a touch-sensitive display 4 and other HID elements, such as physical buttons, trackballs, touch pads, track wheels, etc., as well as accelerometers, compasses, sound and vibration transducers, etc. (collectively, “HID controls”). In addition, mobile device 1 has sufficient other resources (e.g., telephone connectivity, CPU, operating system, etc.) such that it is independently usable (e.g., as a mobile phone or PDA), apart from its role as described herein as a computer input device.

Computer 2 has a display 6, and a graphical user interface (GUI), conventionally operable with a keyboard and mouse (not shown).

Mobile device 1 is connected to computer 2 by a suitable communications connection or channel 3, such as a wireless or wired connection. A wireless connection could be via any wireless medium, such as WiFi®, Bluetooth®, IrDA, a dedicated 2.4 GHz RF channel (such as used for cordless mice), or other communications medium or protocol. A wired connection may be via serial or parallel connection, including USB, Firewire®, PS/2®, serial or parallel port, or other physical media or protocols, including without limitation, the “upload cable” provided with the mobile phone or device and the related interfaces. A wireless connection is shown by way of example, in FIG. 1. In an embodiment in which mobile device 1 is WiFi enabled and computer 2 is connected to a wireless access point 5, connection 3 may be a WiFi connection.

In some embodiments, mobile device 1 may be a mobile phone such as the Apple® iPhone®, the Verizon® Droid® (or other Android® device), the Palm® Pre® or Pixi® (or other WebOS® device), or similar mobile device. As such, mobile device 1 will have functionality, and an associated application programming interface (API), for accepting human input (and/or generating human-perceivable output) to or from the touch screen and/or human interfaces on the mobile device, and making resulting commands available to software applications running on mobile device 1.

In one embodiment, software is provided for mobile device 1 to utilize the HID API, or otherwise accept human input from HID controls, and transmit control signals over connection 3 to computer 2. Such software on mobile device 1 could be adapted to distinguish between HID input intended for the mobile device and HID input intended for the computer, such as by explicit mode shifting, scoping, command escaping, sensor or state transitions, context switching, etc.

Additionally, the display 4 of mobile device 1 could be adapted to provide visual feedback relative to the GUI running on display 6 of computer 2. The GUI representation on display 4 of mobile device 1 may simply be a scaled-down representation of what appears on display 6 of computer 2. However, it need not be, and more often may be a new representation that is selected or abstracted from, or otherwise be different than, the GUI representation shown on display 6 of computer 2.

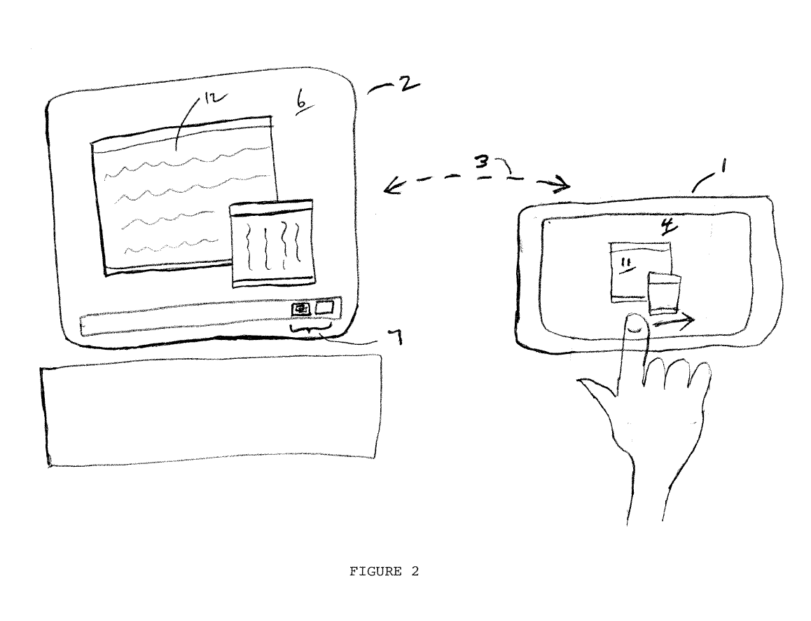

For example, as shown in FIG. 2, display 4 could be adapted to show workspaces currently running in the desktop environment of computer 2. Such a display on mobile device 1 could be similar, for example, to a workspace rendering provided in the workspace pager 7 provided by the Gnome desktop system. In such an embodiment, a window 12 on the desktop of computer 2 would have a miniature counterpart 11 on display 4 of device 1. This can also be seen in workspace pager 7 of computer 2. A gesture performed on the miniature counterpart 11 could be performed in the same or similar manner as it would for a native application window on device 1. The miniature window 11 might, for example, respond as such a window would ordinarily respond under the rules of the mobile device GUI, and the “real” window 12 on computer 2 may respond in the same or equivalent manner. The workspace displays 7 are coordinated and/or synchronized between device 1 and computer 2 by communication over connection 3.

Similar functionality may be provided, for example, for the Microsoft® Windows® Aero® task bar, 3D “Flip” (task switching), or other display GUI elements. Thus, with such an implementation, the Aero interface, which has a number of “touch”-friendly capabilities already built into its software, could take advantage of those GUI capabilities that computer 2 would not be able to utilize natively, with a keyboard and mouse alone. Or, the Aero interface itself might be extended to support additional HID capability provided by the mobile device.

Software and Drivers on Computer 2

In one implementation, the control signals sent to computer 2 could be limited to signals provided by conventional computer HID devices such as mice and/or keyboards, in order to utilize standard drivers and interfaces. However, the same control signals could be used or combined to provide new functionality to computer 2. An extended or different set of control signals could be utilized, through appropriate driver software on computer 2.

In some embodiments, enhanced or modified drivers or GUI managers could be provided on computer 2 to take advantage of additional capabilities provided by the mobile device's HID hardware. For example, as mentioned above with respect to Aero, a compositing window manager such as Compiz (or analogous software under other operating systems and/or window managers), running on computer 2, could be configured to respond to gestures received from mobile device 1.

Alternatively, new drivers or applications could be added to computer 2 to support the additional functionality of device 1. For example, a mobile phone could contain an accelerometer, or a compass, and the driver on the computer could enable the computer to take advantage of this HID functionality from the mobile device, which the computer did not natively possess. Such HID functionality could be of an entirely different class that that available natively to the computer, or provide enhanced modes of operation for features already provided for.

Similarly, the mobile device may provide outputs, such as vibration, speaker output, ring tones, etc., not natively available on the computer, which could be handled by the computer's device driver and thereby incorporated into the computer's HID capabilities.

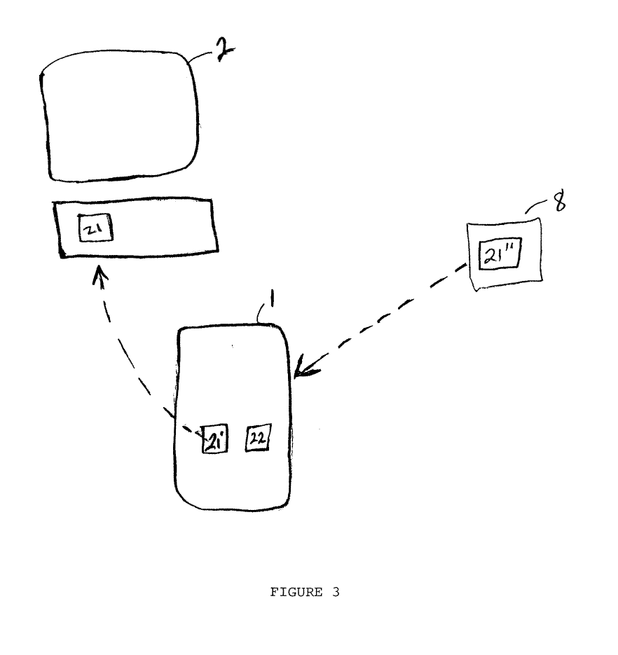

As shown in FIG. 3, driver software 21 on computer 2 could be loaded in the same manner as other device drivers, e.g., built into the operating system, or bound at run time as invoked. Alternatively, driver software 21′ adapted to the specific HID functionality and interfaces of mobile device 1 could be encapsulated within mobile device 1 itself, and downloadable by computer 2 on demand.

The downloaded driver software could provide a plurality of interfaces, or adaptable interfaces, to interoperate with a variety of computers and/or operating systems. Or, a selection of different drivers could be provided, each adapted to the respective supported computers and/or operating systems. Or, the drivers could be tailored to run on a virtual machine, such as a Java® virtual machine, and used on a cross-platform basis for a plurality of different computer/OS types.

In one embodiment, such a Java-based driver, or other driver, could be stored in a manner that automatically mounts on computer 2 when connection 3 is established, automatically launches, etc. In general, an embodiment could be provided in which all requisites for operation are stored on mobile device 1, which could be further configured to begin functioning automatically, and/or provide a user prompt to do so, when a connection is established.

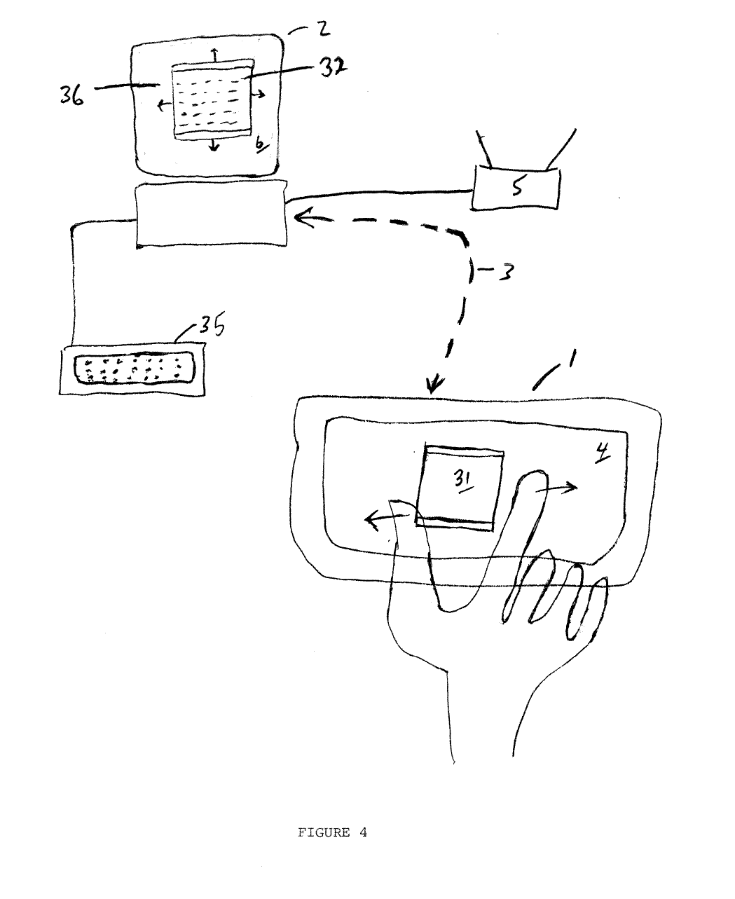

A driver encapsulated within mobile device 1 for which the driver is fashioned, may be updated from time-to-time, directly to mobile device 1, for example, as shown in FIG. 4, wirelessly, from service provider 8, through the software 22 that generally handles software updates for mobile device 1, independent of computer 2. Thus, whenever computer 2 connects to mobile device 1, it will automatically have the most currently released driver 22″ for the specific mobile device.

Enhanced Display Capabilities

The display capabilities of mobile devices are also very attractive. In some embodiments, these may be taken advantage to provide supplemental display space for computer 2. For example, a workspace pager, as in 7, or a dock, status indicator, music player, etc., could be removed from the main display of computer 1, and relocated to the display 4 of mobile device 1.

In embodiments where display 4 is touch sensitive, workspace-related HID commands could be provided through the mobile device, to work with the removed workspace pager display. A separate mode could be provided in the mobile device for it to provide the capabilities of an enhanced touch pad. Thus, in such an implementation, mobile device 1 could serve as a full-featured input device, fully replacing the conventional mouse, and at the same time provide higher-level GUI functionality, such as workspace and application switching, enhanced window manipulation, etc., without encumbering the main computer display, while also providing a high level of visual feedback directly on the input device. Audible, tactile and other feedback could be provided as well.

In other embodiments, display 4 could simply be used as an additional contiguous display space for computer 1, under control of the window management provided on computer 2. A user could use an additional display area as thus provided for expanded screen “real estate”, or to be able to move selected windows or content off of the main display, make more space available for other items on the main display, or to provide enhanced GUI controls for the moved items.

Other Applications

A device as described could also be very useful for roving, standing, or “couch” use, such as with projected displays, for example, audiovisual displays to groups, or home entertainment displays. In such applications, accelerometer and compass functionality could be used to move a screen pointer and activate on-screen controls, freeing the user from the keyboard or mouse, yet not requiring dedicated hand-held controller devices.

Mobile devices often incorporate excellent cameras. In a related application, such a camera could be utilized, within the framework of the present invention, to provide an enhanced webcam for computer 1.

The interface herein could also be used to provide “tethering” to take advantage of the mobile device's Internet connection. More generally, the interface could also be utilized to provide additional functionality to computer 2 such as, for example, autodialing, VOIP functions, a sound server (e.g., running a home sound system from the sound output of the mobile device while obtaining source material from the computer network and controlling the mobile device from a central server on the network), etc.

In many of the described applications, it can be seen that the display contents on screen 4 of mobile device 1 may not necessarily be the same as the display contents of screen 6 of computer 2. Similarly, the HID inputs provided by mobile device 1 are not necessarily tied to existing inputs on computer 1.

Furthermore, mobile device 1 has free-standing functionality of its own. The HID resources used to provide the mobile phone's free-standing functionality are adapted to interface to computer 2, and used to extend the HID functionality of computer 2.

Other variations are also possible. While mobile device 1 has been primarily described as a mobile phone, mobile device 1 could in some embodiments be a PDA, a hand-held media player, or even a dedicated stripped-down device without all of the functionality of a mobile phone, e.g., without telephone network connectivity, GPS, cameras, etc.

Computer Extending HID and Other Capabilities of Mobile Device

interface described herein could be run in reverse, opening a number of other possibilities. In one such “reverse” embodiment, as shown in FIG. 4, computer 2 could be used to extend the HID capabilities of mobile device 1, for example, with a larger screen 6 and a full-sized keyboard 35. Some mobile devices are equipped to utilize external displays of larger than native resolution, as well as external keyboards.

In such an embodiment, computer 2 could be caused to use an application executing on mobile device 1, directing the screen output 36 to display 6 of computer 2, and taking advantage of keyboard 35 associated with computer 2. In such an embodiment, computer 2 could simultaneously use mobile device 1 as an HID device as previously described (i.e., operate the interface both in the “forward” as well as “reverse” directions, in effect, a “full duplex” mode), to also take advantage of the mobile device's enhanced HID capabilities, thereby leveraging the capabilities of both the computer and the mobile device.

For example, while computer 2 is displaying a word processing application shown in window 32, which is actually running on the CPU of mobile device 1, against a word processing data file residing on mobile device 1, a hand gesture on mobile device 1 (applied to miniature window icon 31 on mobile device 1) can be used as GUI HID input for computer 2, expanding word processing window 31 in the example pictured.

Using the full-sized I/O devices of computer 2 in such a manner, in conjunction with mobile device 1, potentially provides application independence, insofar as the applications in question execute on the mobile device's CPU, for which they were designed, with no data conversion issues.

Such an approach also provides for data integrity, in that the application data may be left on the mobile device, and data security, because the application data need not be copied to other persistent storage devices in order to perform tasks involving the data (e.g., editing a word processing file in its native format for mobile device 1's word processing application, using that application on mobile device 1, through the HID interfaces of computer 2).

An embodiment using the mobile device's applications in such a manner may also be adapted to provide other services to the mobile device, such as connectivity to the local LAN and switches, printing services, and the like.

In one scenario, using the various features described above, mobile device 1 could become one's principal computing device, with desktop computers, as may be available, essentially used as “smart terminals” or docking hosts.

Thus, it can be seen that, in accordance with the stated objects, the embodiments described herein make the human input functionality of a mobile phone or similar mobile device available as an HID device for an associated computer having a GUI display, supplementing the HID capabilities of the computer, and also permits the computer to extend the HID capabilities of the mobile device.

Although the present invention has been described in detail, it should be understood that various changes, substitutions, and alterations may be readily ascertainable by those skilled in the art and may be made herein without departing from the spirit and scope of the present invention as defined by the claims.

I claim:

1. A system comprising a computer, a mobile device, and a connection between the computer and the mobile device, the mobile device being operable to receive HID input from a user through a touch-sensitive display screen, and transmit corresponding HID commands to the computer, and the computer being operable to respond to perform GUI operations responsive to the HID commands, wherein the mobile device is operational on a standalone basis without said connection, and wherein the HID commands extend the HID capabilities of the computer.

2. A mobile device having a local touch-sensitive display, HID elements and a connection to a computer having a GUI display, said mobile device being adapted to coordinate a representation of the display on the remote computer with the local display, translating user inputs to the HID elements into commands, and transmitting the HID commands to the remote computer, wherein the GUI representation on the local display may differ from the GUI representation on the computer display.

3. A machine-readable medium containing software comprising a series of instructions executable on a mobile device, the mobile device having a local display, HID elements, and a communications channel to a computer, the computer having a GUI display, said series of instructions comprising instructions for coordinating a representation of the display on the remote computer with the local display, translating user inputs to the HID elements into commands, and transmitting the commands to the remote computer for performing GUI operations responsive to the HID commands, wherein the mobile device is operational on a standalone basis without said connection, and wherein the HID commands extend the HID capabilities of the computer.

4. The machine-readable medium of claim 3, wherein the remote computer has GUI software functionality configured to accept HID commands of the type provided by said instructions executable on the mobile device, wherein the computer lacks HID resources to use such GUI software functionality, and said HID resources are made available to the computer by the mobile device.

5. The machine-readable medium of claim 3, wherein said software further comprises driver software executable on the computer for processing the HID commands from the mobile device.

6. The machine-readable medium of claim 5, wherein said driver software is configured to load automatically on the computer when said connection is established.

7. The machine-readable medium of claim 5, wherein said software further comprises a routine for updating said driver as stored on the mobile device by receiving updates from a service provider.

8. A system comprising a computer, a mobile device, and a connection between the computer and the mobile device, the mobile device having an applications and associated data thereon, and the computer having a display and keyboard and being operable to run said application on the processor of the mobile device, with the associated data on the mobile device, and render the output of said application on the display of the computer and use the keyboard of the computer, wherein the mobile device is operational on a standalone basis without said connection, and wherein the computer display and keyboard extend the HID capabilities of the mobile device.

9. The system of claim 8, wherein the mobile device comprises a touch-sensitive display and is further operable to receive HID input from a user and transmit corresponding HID commands to the computer, and wherein the computer is further operable to perform GUI operations responsive to the HID commands, and wherein said corresponding HID commands extend the HID capabilities of the computer.
